(19) United States
(12) Patent Application Publication
(10) Pub. No.: US 2025/0175517 A1
(43) Pub. Date: May 29, 2025

(54) COMMON EDGE APPLICATION SERVER SELECTION IN EDGE COMPUTING

(71) Applicant: Telefonaktiebolaget LM Ericsson (publ), Stockholm (SE)

(72) Inventors: Wenliang Xu, Shanghai (CN); Fengpei Zhang, Guangzhou (CN)

(21) Appl. No.: 18/851,431

(22) PCT Filed: Mar. 22, 2023
(86) PCT No.: PCT/CN2023/083103

§ 371 Date: Sep. 26, 2024

(30) Foreign Application Priority Data
Mar. 30, 2022 (WO) PCT/CN2022/084042

(51) Int. Cl. H04L 67/1001

(52) U.S. Cl. CPC H04L 67/1001

(57) ABSTRACT

The embodiments herein relate to common or binding Edge Application Server (EAS) selection in edge computing. In some embodiments, there proposes a method performed by a first network function implementing a Binding Server (BS). In an embodiment, the method may comprise the step of receiving, from a second network function implementing an Edge Enabler Server (EES) within an Edge Data Network (EDN), a request message. The request message may include a first parameter indicating information regarding an application in a User Equipment (UE), a second parameter indicating group information of a UE group, a third parameter indicating information regarding a predetermined EAS for the application of the UE. In an embodiment, the method may further comprise the step of determining a binding EAS to be used for the UE or the UE group based on at least one of the first parameter, the second parameter, and third parameter.

### TECHNICAL FIELD

The embodiments herein relate generally to the field of edge computing, and more particularly, the embodiments herein relate to common or binding Edge Application Server (EAS) selection in edge computing.

### BACKGROUND

Edge Computing is a concept that enables services to be hosted close to the service consumers and provides benefits such as efficient service delivery with significant reduction in end-to-end latency and decreased load on the transport network. The benefits of Edge Computing will strengthen the promise of 5G and expand the prospects for several new and enhanced use cases—including virtual and augmented reality, Internet of Things (IoT), Industrial IoT, autonomous driving, real-time multiplayer gaming etc.

The third Generation Partnership Project (3GPP) Technical Specification (TS) 23.558 Release 17 (v17.3.0) specifies the application layer architecture, procedures and information flows necessary for enabling edge applications over 3GPP networks. It includes architectural requirements for enabling edge applications, application layer architecture fulfilling the architecture requirements and procedures to enable the deployment of edge applications.

There are several unsolved key issues when discussing the next release, for example Release 18.

### SUMMARY

The embodiments herein propose methods, network functions, User Equipments (UEs), computer readable medium and computer program product for enabling common or binding EAS selection in edge computing.

In some embodiments, there proposes a method performed by a first network function implementing a Binding Server (BS). In an embodiment, the method may comprise the step of receiving, from a second network function implementing an Edge Enabler Server (EES) within an Edge Data Network (EDN), a request message. The request message may include a first parameter indicating information regarding an application in a User Equipment (UE), a second parameter indicating group information of a UE group, a third parameter indicating information regarding a predetermined EAS for the application of the UE. In an embodiment, the method may further comprise the step of determining a binding EAS to be used for the UE or the UE group based on at least one of the first parameter, the second parameter, and third parameter.

In an embodiment, the step of determining a binding EAS to be used for the UE or the UE group may further comprise at least one of: the step of creating a binding EAS or determining a binding EAS as the predetermined EAS, in response to determining that there is no existing binding EAS, or the step of replacing the existing binding EAS with a binding EAS, in response to determining that there is the existing binding EAS and the binding EAS has better performance than the existing binding EAS.

In an embodiment, the method may further comprise the step of transmitting, to the second network function, a response message. The response message may explicitly or implicitly indicate the binding EAS.

In an embodiment, the binding EAS may be the same as the predetermined EAS, and the response message may indicate that the predetermined EAS is used as the binding EAS.

In an embodiment, the binding EAS may be different from the predetermined EAS, and the response message may indicate the binding EAS and a fourth network function implementing EES associated with the binding EAS.

In an embodiment, the method may further comprise the step of transmitting, to a third network function implementing an EES which are serving at least one UE in the UE group, a notification message. The notification message may indicate the binding EAS and a fourth network function implementing EES associated with the binding EAS.

In an embodiment, the binding EAS may have better average latency performance than the existing binding EAS.

In an embodiment, the request message may further include at least one of a fourth parameter indicating identity of the UE, and a fifth parameter indicating information regarding the EDN.

In an embodiment, the request message may be a group binding request message. In an embodiment, the response message may be a group binding response message. In an embodiment, the notification message may be a group binding notification message.

In an embodiment, the first network function may be located inside the EDN or outside the EDN.

In an embodiment, the method may further comprise the step of storing, in the first network function, the first parameter, the second parameter, the third parameter, the fourth parameter, the fifth parameter, and information regarding the second network function.

In an embodiment, the UE group may include two or more UEs cooperating with each other to support a same function.

In some embodiments, there proposes a method performed by a second network function implementing an EES within an EDN. In an embodiment, the method may comprise the step of receiving, from a first network function implementing a BS, a first message. The first message may explicitly or implicitly indicate a binding EAS to be used for a UE or UE group. In an embodiment, the method may further comprise the step of transmitting, to a functional component implementing an enabler function in the UE, a second message. The second message may explicitly or implicitly indicate that the binding EAS is to be used for the UE.

In an embodiment, at least one of the first and second messages may further indicate a third network function implementing an EES associated with the binding EAS.

In an embodiment, the method may further comprise the step of receiving, from the functional component, a third message. The third message may include a first parameter indicating information regarding an application in the UE, a second parameter indicating group information of the UE group, a third parameter indicating information regarding a predetermined EAS for the application of the UE. In an embodiment, the method may further comprise the step of transmitting, to the first network function, a fourth message including the first parameter, the second parameter, and the third parameter.

In an embodiment, the third message may further include a fourth parameter indicating identity of the UE. In an embodiment, the fourth message may further include the fourth parameter, and a fifth parameter indicating information regarding the EDN.

In an embodiment, the binding EAS may be the same as the predetermined EAS, and the first and second messages may indicate that the predetermined EAS is used as the binding EAS.

In an embodiment, the first network function may be located inside the EDN or outside the EDN.

In an embodiment, the binding EAS may have better average latency performance than an existing binding EAS.

In an embodiment, the first message may be a group binding response message or a group binding notification request message. In an embodiment, the second message may be an EAS selection declaration response message or an EAS reselection request message. In an embodiment, the third message may be an EAS selection declaration request message. In an embodiment, the fourth message may be a group binding request message.

In an embodiment, the UE group may include two or more UEs cooperating with each other to support a same function.

In some embodiments, there proposes a method performed by a functional component implementing an enabler function in a UE. In an embodiment, the method may comprise the step of receiving, from a second network function implementing an EES, a first message. The first message may explicitly or implicitly indicate a binding EAS to be used for a UE group including the UE.

In an embodiment, the first message may further indicate a third network function implementing an EES associated with the binding EAS.

In an embodiment, the method may further comprise the step of transmitting, to the second network function, a second message. The second message may include a first parameter indicating information regarding an application in the UE, a second parameter indicating group information of a UE group, a third parameter indicating information regarding a predetermined EAS for the application of the UE, and a fourth parameter indicating identity of the UE.

In an embodiment, the first message may indicate that the predetermined EAS may be used as the binding EAS.

In an embodiment, the binding EAS may have better average latency performance than an existing binding EAS.

In an embodiment, the first message may be an EAS selection declaration response message or an EAS reselection request message. In an embodiment, the second message may be an EAS selection declaration request message.

In an embodiment, the UE group may include two or more UEs cooperating with each other to support a same function.

In some embodiments, there proposes a network function, comprising: at least one processor; and a non-transitory computer readable medium coupled to the at least one processor. In an embodiment, the non-transitory computer readable medium may store instructions executable by the at least one processor, whereby the at least one processor may be configured to perform the above method. In an embodiment, the network function may be configured as either the above first network function or the above second network function.

In some embodiments, there proposes a UE, comprising: at least one processor; and a non-transitory computer readable medium coupled to the at least one processor. In an embodiment, the non-transitory computer readable medium may store instructions executable by the at least one processor, whereby the at least one processor may be configured to perform the above method. In an embodiment, the UE may be configured as the above UE.

In some embodiments, there proposes a computer readable medium stores computer readable code, which when run on an apparatus, causes the apparatus to perform any of the above methods.

In some embodiments, there proposes a computer program product stores computer readable code, which when run on an apparatus, causes the apparatus to perform any of the above methods.

The embodiments herein may provide support to the use cases requiring a group of UEs to connect to the same EAS to optimize the latency or avoid complex EAS synchronization.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for enabling Edge applications, according to the embodiments herein;

FIGS. 2A and 2B are schematic signaling charts showing the messages in a common EAS selection coordination inside EDN, according to the embodiments herein;

FIG. 3 is a schematic signaling chart showing the messages in a common EAS reselection coordination inside EDN, according to the embodiments herein;

FIG. 4 is a schematic signaling chart showing the messages in a common EAS selection coordination across EDNs, according to the embodiments herein;

FIG. 5 is a schematic flow chart showing an example method in the first network function, according to the embodiments herein;

FIG. 6 is a schematic flow chart showing an example method in the second network function, according to the embodiments herein;

FIG. 7 is a schematic flow chart showing an example method in the UE, according to the embodiments herein;

FIG. 8 is a schematic block diagram showing an example first network function, according to the embodiments herein;

FIG. 9 is a schematic block diagram showing an example second network function, according to the embodiments herein;

FIG. 10 is a schematic block diagram showing an example UE, according to the embodiments herein;

FIG. 11 is a schematic block diagram showing an example computer-implemented apparatus, according to the embodiments herein;

FIG. 12 is a schematic block diagram showing another example architecture for enabling Edge applications, according to the embodiments herein; and

FIG. 13 is a schematic signaling chart showing the messages in a common EAS selection, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

In 3GPP Release 17, 3GPP aims to provide native support of Edge Computing in 3GPP networks. These efforts include initiatives across several working groups in 3GPP including System Aspects (SA) 6, SA2, SA3, SA4 and SA5, which cover application layer architecture, core network enhancement, security, media processing, and management aspects respectively.

SA6 initiated normative specification work on the architecture for enabling Edge Applications (EDGEAPP). The objective of the work is to define an enabling layer to facilitate communication between the Application Clients (AC) running on the UE and the EAS deployed on the EDN. This includes aspects of service provisioning and EAS discovery. In addition, the work aims to provide support services such as application context transfer between EASs for service continuity, service enablement and capability exposure Application Programming Interfaces (APIs) towards the EAS.

Currently, EDGEAPP only supports standalone EAS selection, i.e., the EAS selection procedure only considers the context of the target AC, without considering the context of other ACs.

An Application Service Provider (ASP) may deploy several EASs providing the same service in different locations within one or more EDNs. For certain use cases involving real-time communication in a multi-user session, both between AC and EAS and, between different ACs via the EAS, it may be necessary or beneficial to use services from a single common EAS to meet the strict latency requirements and to avoid the need for inter-EAS synchronization.

The use cases may include, but not limit to:
A group of robots coordinating together on a manufacturing factory
A team of surgeons using Virtual Reality (VR) headsets and robotic surgery equipment to operate together on a patient
A group of trucks using vehicle to everything (V2X) for platooning.

Dependent on the use case, the edge enabler layer may apply different additional criteria to determine this common EAS, e.g., it could be desirable to determine the EAS so that the latency for all the ACs in the session is approximately the same or that the latency for a specific AC is minimized.

Meanwhile, the edge computing study TR 23.700-98 v0.5.1 describes several Key Issues (KIs).

KI#17 (Support of constrained devices for Edge) says:

“An ASP can deploy several EASs providing the same service in different locations within the EDN.

For certain use cases involving real-time communication in a multi-user session, both between AC and EAS and between different ACs via the EAS, it may be necessary or beneficial to use services from a single common EAS to meet the strict latency requirements and to avoid the need for inter-EAS synchronization. The use cases may include, for example, a team of robots coordinating together on a manufacturing floor, a team of surgeons using VR headsets and robotic surgery equipment to operate together on a patient, or a group of trucks using V2X for platooning.

Dependent on the use case, the edge enabler layer may apply different additional criteria to determine this common EAS; e.g. it could be desirable to determine the EAS so that the latency for all the ACs in the session is approximately the same or that the latency for a specific AC is minimized.

Open issues:
1) Whether and how the ACs/Edge Enabler Clients (EECs) of different users can select or be provisioned the same EAS within an EDN?
NOTE: This open issue is dealing with the issue how different EECs can perform EAS discovery so that they select the same EAS within an EDN, whereas KI#13 is dealing with the issue how, after different EECs have selected different EASs located in different EDNs, these EASs can synchronize their contexts.
2) Whether and how the ACs/EECs of different users can select or be provisioned a common EAS, even if initially the EECs are communicating with different EDNs?
3) Whether and how the edge enabler layer can support service continuity to ensure that when ACs require the use of service from a common EAS and an Application Context Relocation (ACR) operation is needed, ACR operations can be coordinated so that upon completion of the ACR operations the ACs again have services provided by a common EAS”.

In view of deficiencies with the current EAS selection procedure, the embodiments provide a common EAS selection mechanism extending the existing EAS selection declaration/announcement procedure (sol#15 in 3GPP TR 23.700-98) for the application.

In an embodiment, the UEs may provide group information when they declare the EAS selection. In an embodiment, the BS may recommend a recommended EAS and/or EES to a UE. In an embodiment, the BS may change the common EAS when more binding information is received.

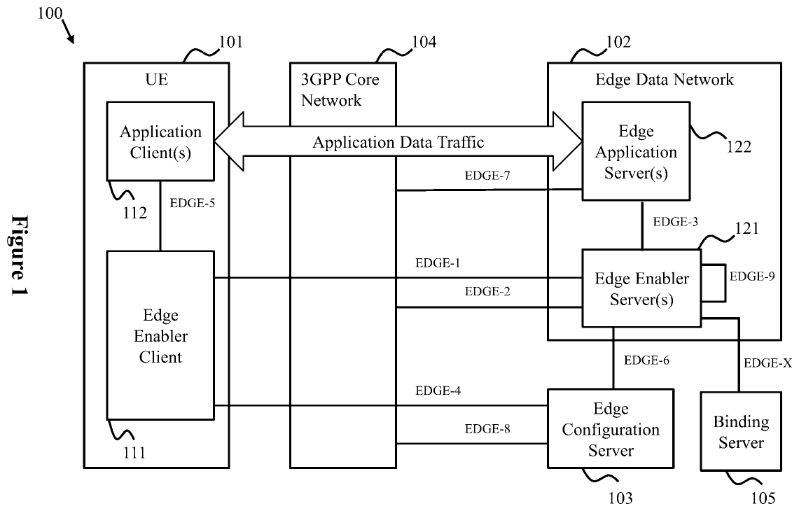

FIG. 1 is a schematic block diagram showing example architecture 100 for enabling edge applications, according to the embodiments herein.

The functional entities may include:
Edge Enabler Server (EES): the EES 121 may provide supporting functions needed for the EASs 122 and the EEC 111, e.g., EEC registration, EAS discovery and network APIs for EAS and service continuity support.
Edge Enabler Client (EEC): the EEC 111 may provide supporting functions needed for the AC(s) 112, e.g., retrieval and provisioning of configuration information to enable application data traffic, and EAS discovery.
Edge Configuration Server (ECS): the ECS 103 may provide supporting functions needed for the EEC 111 to connect with an EES 121, e.g., provisioning of edge configuration information to the EEC 111, and EES discovery.
Application Client (AC): the AC 112 is the application resident in the UE 101 performing the client function.
Edge Application Server (EAS): the EAS 122 is the application server resident in the EDN 102, performing the server functions. The AC 112 connects to the EAS 122 in order to avail the services of the application with the benefits of edge computing.

In addition, a Binding Server (BS) 105 is introduced into EDGEAPP to coordinate the common EAS selection inside EDN or across EDNs. The EES 121 can interact with the BS 105 through EDGE-X reference point. The EES 121 can store, update and remove the binding information via EDGE-X reference point. The BS 105 can be deployed either in an EDN if no cross-EDN coordination is required or in a central data network if cross-EDN coordination is required.

In an embodiment, the wireless communication system 100 may be configured in an OTT scenario. The OTT connection may be transparent in the sense that the participating communication devices through which the OTT connection passes are unaware of routing of uplink and downlink communications. For example, a base station may not or need not be informed about the past routing of an incoming downlink communication with data originating from the EAS 122, the EES 121, the ECS 103, or the BS 105 to be forwarded (e.g., handed over) to a connected UE 101. Similarly, the base station needs not to be aware of the future routing of an outgoing uplink communication originating from the UE 101 towards the EAS 122, the EES 121, the ECS 103, or the BS 105.

It should also be understood that, a network function can be implemented either as a network element on a dedicated hardware, as a software instance running on a dedicated hardware, or as a virtualized function instantiated on an appropriate platform, e.g. on a cloud infrastructure.

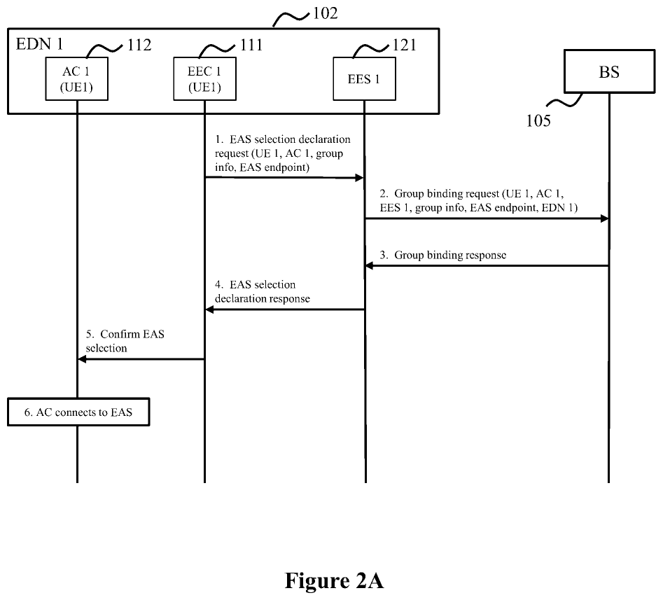

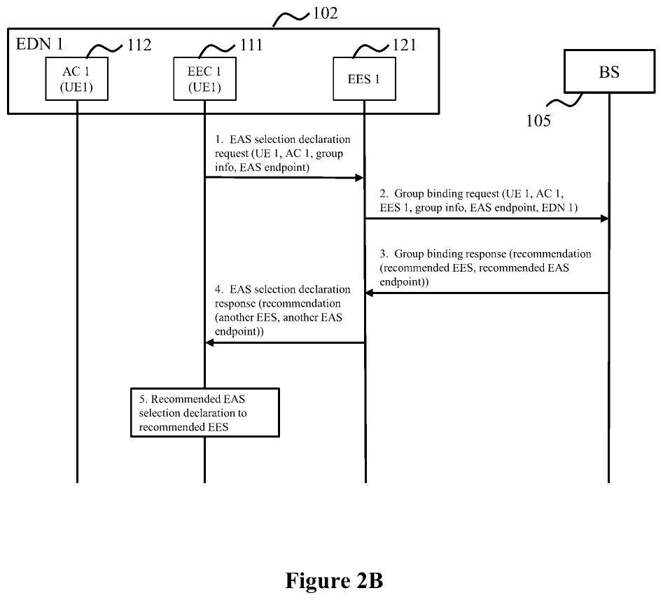

FIGS. 2A and 2B are schematic signaling charts showing the messages in a common EAS (also be referred as binding EAS) selection coordination inside EDN, according to the embodiments herein.

This procedure describes when a UE in a UE group discovers EAS and declares EAS selection, how BS will coordinate the common EAS selection inside an EDN.

Here, the UE group includes two or more UEs cooperating with each other to support a same function. For example, the UE group may include two or more UEs communicating with each other for operating together on a patient, for manufacturing, or for platooning.

For example, a UE group may include UEs that: (1) have the same application (with the same AC ID) installed, (2) either UEs need to exchange information between them via an EAS; or an EAS needs information from some UEs in the UE group in order to serve other UEs.

Besides, for another example, the UE group may include UEs that have the different (corresponding) applications installed, for example, the teleoperated driving application may have AC for operator and AC for teleoperated vehicle, the AC IDs could be different) but they are using the same EAS application service (with the same EAS ID).

As shown in FIG. 2A, in an embodiment, the signaling chart may include the following messages or steps:

Step 1: After an EAS discovery, the EEC 111 (also shown as the first EEC or EEC 1) may inform the EES 121 (also shown as the first EES or EES 1) with the selected EAS information including for example information of the EAS (such as EAS endpoint or EAS ID), information of the UE (such as UE ID), information of the AC 112 (such as AC ID) and group information (e.g., group id) of the UE group. The UE group may include one or more UEs which host the same application (such as AC). Note that, if the AC ID is different per UE, the information of the UE (such as UE ID) may be omitted.

Step 2: The EES 121 may send group binding request message to the BS 105 with the received information from the EEC 111. In addition, the EES 121 may also send the information of the EDN 102 (such as EDN ID). Note that, if the BS 105 is located within the EDN 102, the information of the EDN 102 may be omitted.

Step 3: In an example, if there is no existing binding found for the UE group, the BS 105 may create new binding information and respond group binding request with a result indicating OK to proceed with the requested EAS. That is, the BS 105 may implicitly indicate the binding EAS (also referred as common EAS).

In another example, if there is an existing binding found for the UE group, and if the selected EAS is the same as the one in the existing binding, the BS 105 may respond group binding request with a result indicating OK to proceed with the requested EAS. That is, the BS 105 may implicitly indicate the binding EAS (also referred as common EAS).

Step 4: The EES 121 may respond the EAS selection to the EEC 111. In an example, the EES 121 may implicitly indicate the binding EAS to be used by the EEC 111, by confirming the selected EAS is OK to be used.

Step 5: The EEC 111 may confirm the EAS selection of the AC 112. In an example, the EEC 111 may confirm the selected EAS is OK to be used.

Step 6: Finally, the AC 111 may connect to the selected EAS.

As shown in FIG. 2B, in an embodiment, the signaling chart may include the following messages or stops:

Steps 1-2: these steps are similar to those in FIG. 2A, and the details are omitted here.

Step 3: If the selected EAS is different from the one in the existing binding, the BS 105 may respond group binding request with recommended EES and EAS information. Here, the recommended EAS may be an existing binding EAS, and the recommended EES may be the EES on which the binding EAS is registered. That is, the BS 105 may explicitly indicate the binding EAS (also referred as common EAS) and an associated EES.

Step 4: The EES 121 may respond the recommended EES and EAS to the EEC 111.

Step 5: The EEC 111 may inform the recommended EES with the recommended EAS information. Then, the AC 112 may follow the recommendation and start to connect to the recommended EAS.

In addition, in FIG. 2A and FIG. 2B, the binding information, including UE ID, AC ID, EES ID, EAS endpoint, EDN ID and group information (e.g. group ID), may be maintained in the BS 105.

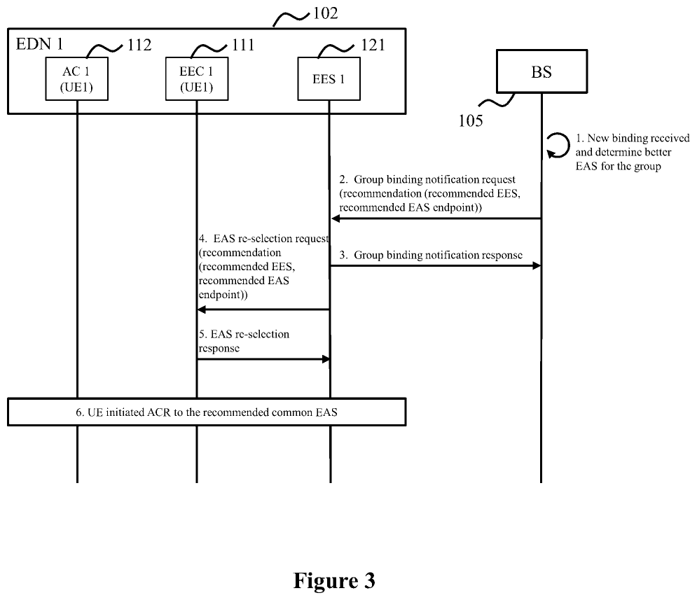

FIG. 3 is a schematic signaling chart showing the messages in a common EAS reselection coordination inside EDN, according to the embodiments herein.

This procedure describes when BS receives some binding information and determines a better common EAS for the UE group, how BS coordinates UEs in the UE group to re-select to this new common EAS.

In an embodiment, the signaling chart may include the following messages or steps:

Step 1: When the BS 105 receives a new binding request (referring to steps 1 and 2 of FIGS. 2A and 2B) and determines there may be a better EAS for the group, e.g., considering the average latency between UE group members and the common EAS. For example, the BS 105 may determine a new binding EAS to replace the existing binding EAS, since the new binding EAS has a better performance, such as average latency performance.

Step 2: The BS 105 may send group binding notification request message to the EESs that are serving UEs in the group (such as the EES 121) with the recommended EES and EAS information. In an example, these EESs received the existing binding EAS information and are cooperating with the existing binding EAS.

Step 3: The EES 121 may send a response to the BS 105.

Step 4: The EES 121 may send an EAS re-selection request message to EECs in the group with the recommended EES and EAS information. In an example, these EECs received the existing binding EAS information and are cooperating with the existing binding EAS.

Step 5: The EEC 111 may send a response to the EES 121.

Step 6: The EEC 111 may trigger a UE initiated ACR to the recommended EAS; the details for the ACR may be referred to 3GPP TS23.558 and thus are omitted here.

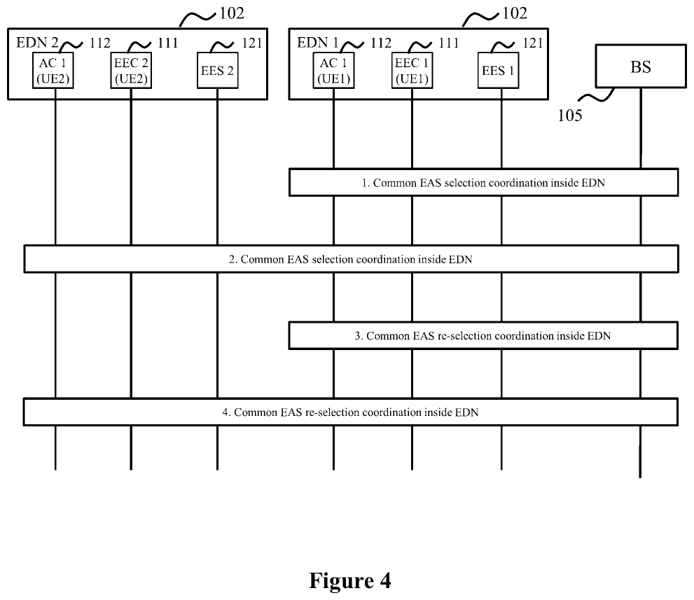

FIG. 4 is a schematic signaling chart showing the messages in a common EAS selection coordination across EDNs, according to the embodiments herein.

Since the UEs in a UE group may be distributed across multiple EDNs, the BS can also coordinate common EAS selection and re-selection across EDNs. In this case, the BS may determine best common EES and EAS in each EDNs, for example, considering the average latency between UE group members and the common EAS, for either of EAS selection or EAS reselection, as shown in FIG. 4. In this case, the BS 105 may be located outside either EDN, for example configured as a central binding server.

The embodiments herein may provide support to the use cases requiring a group of UEs to connect to the same EAS to optimize the latency or avoid complex EAS synchronization.

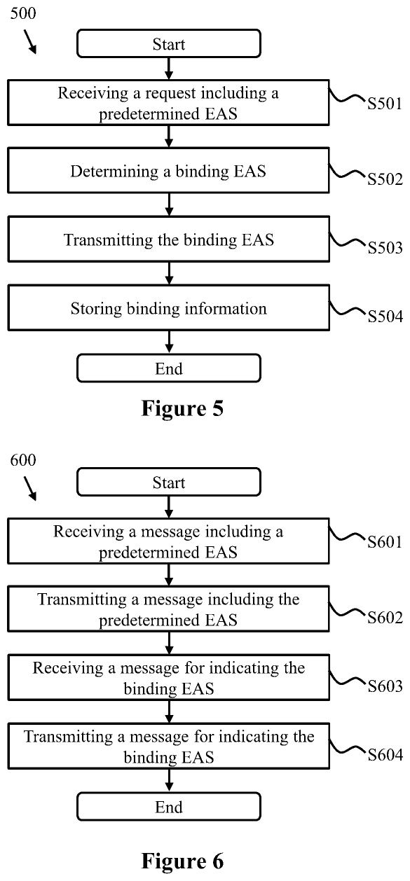

FIG. 5 is a schematic flow chart showing an example method 500 in the first network function, according to the embodiments herein. In an embodiment, the flow chart in FIG. 5 may be implemented in the first network function (such as the BS 105) in FIGS. 1-4.

The method 500 may begin with step S501, in which the first network function (such as the BS 105) may receive, from a second network function implementing an EES within an EDN, a request message, as shown in FIGS. 2A-3. The request message may include a first parameter indicating information regarding an application in a UE, a second parameter indicating group information of a UE group, a third parameter indicating information regarding a predetermined EAS for the application of the UE.

In an embodiment, the request message may further include at least one of a fourth parameter indicating identity of the UE, and a fifth parameter indicating information regarding the EDN.

In an embodiment, the first network function may be located inside the EDN (as shown in FIGS. 2A-3) or outside the EDN (as shown in FIG. 4).

In an embodiment, the UE group may include two or more UEs cooperating with each other to support a same function.

In an embodiment, the method may further comprise the step S502, in which the first network function may determine a binding EAS to be used for the UE or the UE group based on at least one of the first parameter, the second parameter, and third parameter. The determined binding EAS may be an existing binding EAS or a new binding EAS.

In an embodiment, the step S502 of determining a binding EAS to be used for the UE or the UE group may further comprise: the step of creating a binding EAS or determining a binding EAS as the predetermined EAS, in response to determining that there is no existing binding EAS.

In another embodiment, the step S502 of determining a binding EAS to be used for the UE or the UE group may further comprise: the step of replacing the existing binding EAS with a binding EAS, in response to determining that there is the existing binding EAS and the binding EAS has better performance than the existing binding EAS.

In an embodiment, the method may further comprise the step S503, in which the first network function may transmit, to the second network function which requests a new binding, a response message. The response message may explicitly or implicitly indicate the binding EAS.

In an embodiment, the binding EAS may be the same as the predetermined EAS, and the response message may indicate that the predetermined EAS is used as the binding EAS.

In an embodiment, the binding EAS may be different from the predetermined EAS, and the response message may indicate the binding EAS and a fourth network function implementing EES associated with the binding EAS.

In another embodiment, in the step S503, the first network function may transmit, to a third network function implementing an EES which are serving at least one UE in the UE group together with the existing binding EAS, a notification message. The notification message may indicate the binding EAS and a fourth network function implementing EES associated with the binding EAS.

In an embodiment, the binding EAS may have better average latency performance than the existing binding EAS.

In an embodiment, the method may further comprise the step S504, in which the first network function may store the first parameter, the second parameter, the third parameter, the fourth parameter, the fifth parameter, and information regarding the second network function.

In an embodiment, the request message may be a group binding request message. In an embodiment, the response message may be a group binding response message. In an embodiment, the notification message may be a group binding notification message.

Note that, the above steps S502-S503 and Step S504 may be perform in any manner, for example, performed in any sequence, performed at the same time, or performed separately.

The above steps are only examples, and the first network function may perform any actions described with respect to FIGS. 1-4.

FIG. 6 is a schematic flow chart showing an example method 600 in the second network function, according to the embodiments herein. In an embodiment, the flow chart in FIG. 6 may be implemented in the second network function (such as the EES(s) 121) in FIGS. 1-4.

In an embodiment, the method may comprise the step S601, in which the second network function may receive, from the functional component, a first message. The first message may include a first parameter indicating information regarding an application in the UE, a second parameter indicating group information of the UE group, a third parameter indicating information regarding a predetermined EAS for the application of the UE.

In an embodiment, the method may further comprise the step S602, in which the second network function may transmit, to the first network function, a fourth message including the first parameter, the second parameter, and the third parameter.

In an embodiment, the first message may further include a fourth parameter indicating an identity of the UE. In an embodiment, the second message may further include the fourth parameter, and a fifth parameter indicating information regarding the EDN.

In an embodiment, the method may further comprise the step S603, in which the second network function may receive, from a first network function implementing a BS, a third message. The third message may explicitly or implicitly indicate a binding EAS to be used for a UE or UE group.

In an embodiment, the method may further comprise the step S604, in which the second network function may transmit, to a functional component implementing an enabler function in the UE, a fourth message. The fourth message may explicitly or implicitly indicate that the binding EAS is to be used for the UE.

In an embodiment, at least one of the third and fourth messages may further indicate a third network function implementing an EES associated with the binding EAS.

In an embodiment, the binding EAS may be the same as the predetermined EAS, and the third and fourth messages may indicate that the predetermined EAS is used as the binding EAS.

In an embodiment, the first network function may be located inside the EDN or outside the EDN.

In an embodiment, the binding EAS may have better average latency performance than an existing binding EAS.

In an embodiment, the first message may be an EAS selection declaration request message. In an embodiment, the second message may be a group binding request message.

In an embodiment, the third message may be a group binding response message or a group binding notification request message. In an embodiment, the fourth message may be an EAS selection declaration response message or an EAS reselection request message.

In an embodiment, the UE group may include two or more UEs cooperating with each other to support a same function.

Note that, the step S601 and S602 may be omitted for some of the second network functions, for example, for the EES(s) which are serving at least one UE in the UE group together with the existing binding EAS.

The above steps are only examples, and the second network function may perform any actions described with respect to FIGS. 1-4.

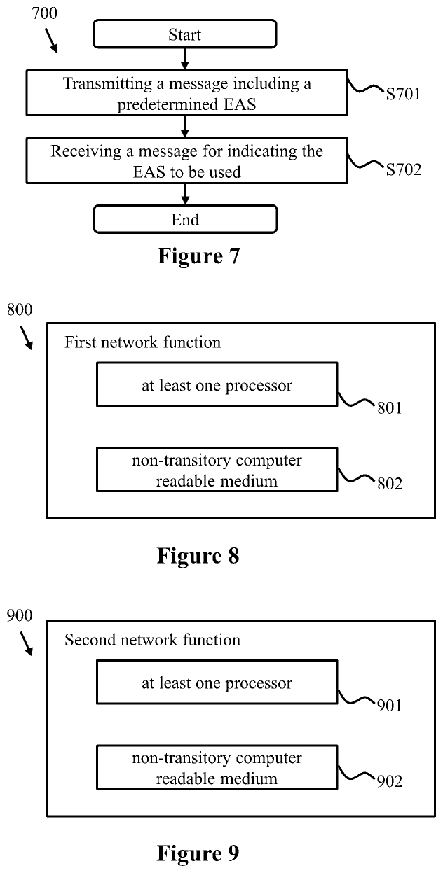

FIG. 7 is a schematic flow chart showing an example method 700 in the UE, according to the embodiments herein. In an embodiment, the flow chart in FIG. 7 may be implemented in the UE (such as the UE 101) in FIGS. 1-4.

In an embodiment, the method may comprise the step S701, in which a functional component implementing an enabler function (such as the EEC 111) in the UE may transmit, to the second network function, a first message. The first message may include a first parameter indicating information regarding an application in the UE, a second parameter indicating group information of a UE group, a third parameter indicating information regarding a predetermined EAS for the application of the UE, and a fourth parameter indicating identity of the UE.

In an embodiment, the method may further comprise the step S702, in which the functional component implementing an enabler function in the UE may receive, from a second network function implementing an EES, a second message. The second message may explicitly or implicitly indicate a binding EAS to be used for a UE group including the UE.

In an embodiment, the second message may further indicate a third network function implementing an EES associated with the binding EAS.

In an embodiment, the second message may indicate that the predetermined EAS may be used as the binding EAS.

In an embodiment, the binding EAS may have better average latency performance than an existing binding EAS.

In an embodiment, the first message may be an EAS selection declaration request message. In an embodiment, the second message may be an EAS selection declaration response message or an EAS reselection request message.

In an embodiment, the UE group may include two or more UEs cooperating with each other to support a same function.

Note that, the step S701 may be omitted for some of the UEs, for example, for the UE(s) which are connected and served by the existing binding EAS.

The above steps are only examples, and the UE or its functional component(s) may perform any actions described with respect to FIGS. 1-4.

FIG. 8 is a schematic block diagram showing an example first network function (such as the BS 105), according to the embodiments herein.

In an embodiment, the first network function 800 may include at least one processor 801; and a non-transitory computer readable medium 802 coupled to the at least one processor 801. The non-transitory computer readable medium 802 may store instructions executable by the at least one processor 801, whereby the at least one processor 801 is configured to perform the steps in the example method 500 as shown in the schematic flow chart of FIG. 5; the details thereof are omitted here.

Note that, the first network function 800 may be implemented as hardware, software, firmware and any combination thereof. For example, the first network function 800 may include a plurality of units, circuities, modules or the like, each of which may be used to perform one or more steps of the example method 500 or one or more steps shown in FIGS. 1-4 related to the first network function (such as the BS 105).

It should be understood that, the first network function 800 may be implemented either as a network element on a dedicated hardware, as a software instance running on a dedicated hardware, or as a virtualized function instantiated on an appropriate platform, e.g. on a cloud infrastructure.

FIG. 9 is a schematic block diagram showing an example second network function (such as the EES(s) 121), according to the embodiments herein.

In an embodiment, the second network function 900 may include at least one processor 901; and a non-transitory computer readable medium 902 coupled to the at least one processor 901. The non-transitory computer readable medium 902 may store instructions executable by the at least one processor 901, whereby the at least one processor 901 is configured to perform the steps in the example method 600 as shown in the schematic flow chart of FIG. 6; the details thereof are omitted here.

Note that, the second network function 900 may be implemented as hardware, software, firmware and any combination thereof. For example, the second network function 900 may include a plurality of units, circuities, modules or the like, each of which may be used to perform one or more steps of the example method 600 or one or more steps shown in FIGS. 1-4 related to the second network function (such as the EES(s) 121).

It should be understood that, the second network function 900 may be implemented either as a network element on a dedicated hardware, as a software instance running on a dedicated hardware, or as a virtualized function instantiated on an appropriate platform, e.g. on a cloud infrastructure.

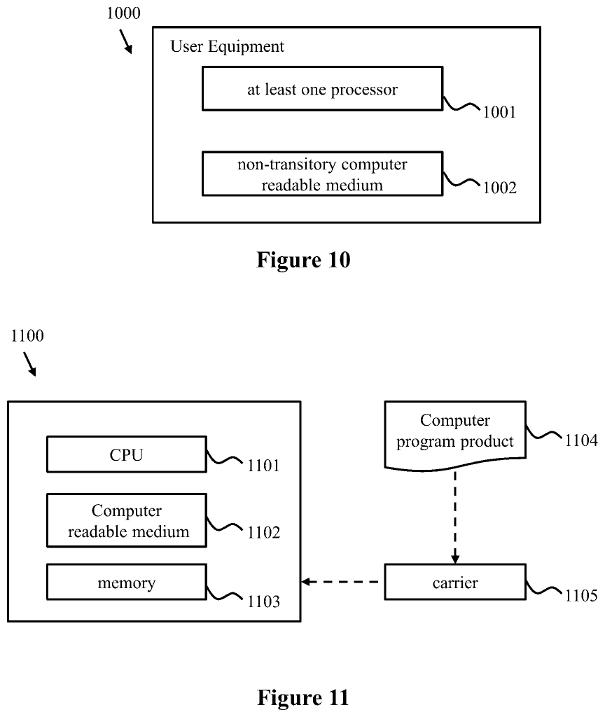

FIG. 10 is a schematic block diagram showing an example UE, according to the embodiments herein.

In an embodiment, the UE 1000 may include at least one processor 1001; and a non-transitory computer readable medium 1002 coupled to the at least one processor 1001. The non-transitory computer readable medium 1002 may store instructions executable by the at least one processor 1001, whereby the at least one processor 1001 is configured to perform the steps in the example method 700 as shown in the schematic flow chart of FIG. 7; the details thereof are omitted here.

Note that, the UE 1000 may be implemented as hardware, software, firmware and any combination thereof. For example, the UE 1000 may include a plurality of units, circuities, modules or the like, each of which may be used to perform one or more steps of the example method 700 or one or more steps shown in FIGS. 1-4 related to the UE 101 and its functional component (such as EEC 111 and/or AC 112).

FIG. 11 is a schematic block diagram showing an example computer-implemented apparatus 1100, according to the embodiments herein. In an embodiment, the apparatus 1100 may be configured as any of the above mentioned apparatus, such as the UE 101 and its functional component (such as EEC 111 and/or AC 112), the first network function (such as the EES(s) 121), the second network function (such as the EAS(s) 122), or the third network function (such as the ECS 103).

In an embodiment, the apparatus 1100 may include but not limited to at least one processor such as Central Processing Unit (CPU) 1101, a computer-readable medium 1102, and a memory 1103. The memory 1103 may comprise a volatile (e.g., Random Access Memory, RAM) and/or non-volatile memory (e.g., a hard disk or flash memory). In an embodiment, the computer-readable medium 1102 may be configured to store a computer program and/or instructions, which, when executed by the processor 1101, causes the processor 1101 to carry out any of the above mentioned methods.

In an embodiment, the computer-readable medium 1102 (such as non-transitory computer readable medium) may be stored in the memory 1103. In another embodiment, the computer program may be stored in a remote location for example computer program product 1104 (also may be embodied as computer-readable medium), and accessible by the processor 1101 via for example carrier 1105.

The computer-readable medium 1102 and/or the computer program product 1104 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Study 3GPP TR 23.700-98 v0.5.1 (2022-03).

Title: Common EAS selection solution

Introduction:

This contribution proposes a new solution to support common EAS selection.

Reason for change:

This solution addresses KI#17 open issues:
1) Whether and how the ACs/EECs of different users can select or be provisioned the same EAS within an EDN?
2) Whether and how the ACs/EECs of different users can select or be provisioned a common EAS, even if initially the EECs are communicating with different EDNs?
3) Whether and how the EEL can support service continuity to ensure that when ACs require the use of service from a common EAS and an ACR operation is needed, ACR operations can be coordinated so that upon completion of the ACR operations the ACs again have services provided by a common EAS.

Proposed changes:

*** 1st Change *** (the proposed change includes the following the content to be added to the 3GPP Technical Study 23.700-98)

7.x Solution #X: common EAS selection

7.x.1 Architecture enhancements

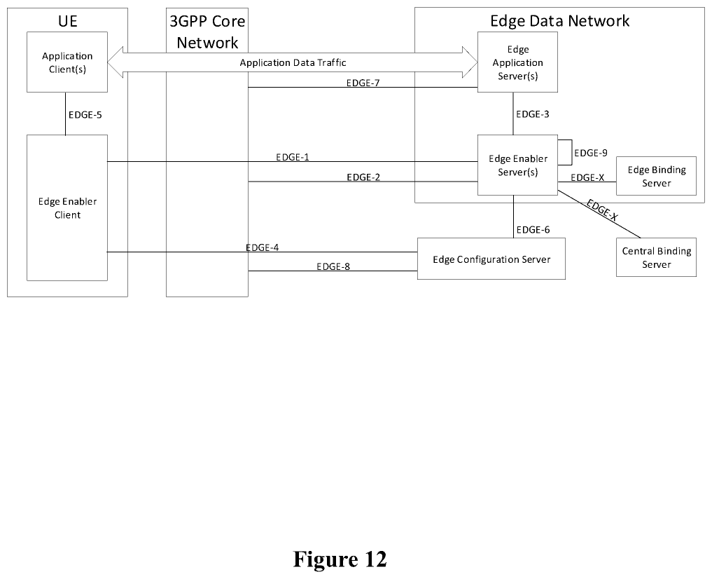

FIG. 7.x.1-1 (notes: referring to the above FIG. 12): EDGEAPP architecture enhanced with binding server

The EDGE-X reference point is introduced to support EES interaction with binding server. The EES can store, update and remove the binding information via EDGE-X reference point.

The binding server can be deployed in an edge cloud or a central cloud.

7.x.2 Solution Description

This solution addresses KI#17.

The UEs can be grouped together to consume EAS services on the same EAS endpoint.

The group information (e.g. group id) can be used as part of the binding information to support anchor those UEs to the same EAS. The binding information are maintained on a Binding Server (BS). When an EES is aware of the selected EAS (e.g. via EEC sent EAS selection declaration), the BS is contacted by the EES and the BS can decide whether to proceed the the currently selected EAS or instruct to use another EAS (which already has other established session(s) for the group).

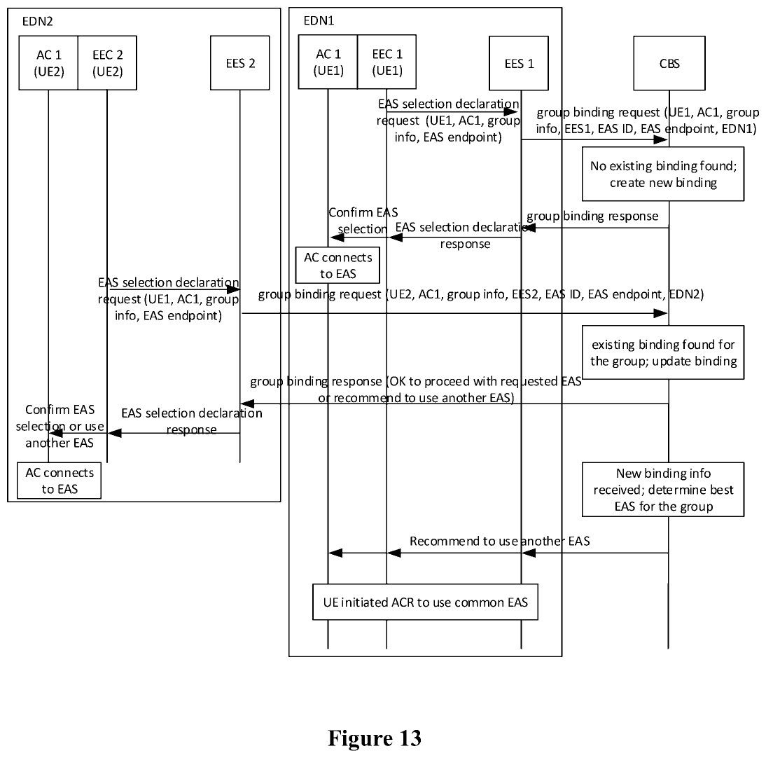

It is possible that UE members are within different EDNs. The EDN id is used to identify EDN and is also part of the binding information. FIG. 7.x.2 (notes: referring to the above FIG. 13) shows the detailed procedure with a Central Binding Server (CBS) deployed.

NOTE: Cross EDN application data synchronization for the UE group can exist and UE group members are anchored in the same EAS per EDN as such.

Pre-Conditions:
1. The EEC is aware of the group info from AC via EDGE-5 reference point.

FIG. 7.x.2-1 (notes: referring to the above FIG. 13): select a common EAS for UEs

In EDN1:
1. After EAS discovery, EEC 1 informs EES 1 with the selected EAS information including EAS ID, EAS endpoint, UE ID (of UE1), AC ID (of AC1) and group info (e.g. group id x).
2. The EES 1 sends group binding request message to CBS with the received information from EEC 1 and in addition the EDN id (of EDN 1).
3. The CBS creates a new binding information for the UE group and responds group binding request with a result indicating OK to proceed with the requested EAS.
4. The EES 1 responds the EAS selection to the EEC 1 and consequently AC1 connects to the selected EAS.

In EDN2:
1. After EAS discovery, EEC 2 informs EES 2 with the selected EAS information including EAS ID, EAS endpoint, UE ID (of UE2), AC ID (of AC1) and group info (e.g. group id x).
2. The EES 2 sends group binding request message to CBS with the received information from EEC 2 and in addition the EDN id (of EDN 2).
3. The CBS finds existing binding information for the UE group based on group info and responds with a result indicating OK to proceed with the requested EAS or recommendation to use another EAS (including the associated EES info).
4. The EES 2 responds the EAS selection to the EEC 2 and consequently AC1 connects to either the previously selected EAS or another EAS (which is the common EAS serving other UE group members).

The CBS maintain the binding information for the UE group. The CBS can decide whether to anchor all UE group members distributed in several EDNs to a common EAS considering average latency between UE group member and the common EAS; or to anchor UE group members within their residing EDNs.

NOTE: CBS can be deployed in each EDN (i.e. CBS becomes EBS) if there is no cross-EDN coordination required.

When there is new binding information received for the UE group, the CBS determines the best EAS for the UE group and notifies EES with the new EAS recommendation (including the associated EES info for the new EAS). The EES in turn notifies the EEC, and the UE side initiated ACR procedure is used to relocate application session to the new common EAS.

7.x.3 Solution Evaluation

This clause provides an evaluation of the solution.

End of Changes

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### ABBREVIATIONS

3GPP 3rd Generation Partnership Project
5G 5th Generation Partnership Project, New Radio
AC Application Client
ACR Application Context Relocation
API Application Programming Interface
ASP Application Service Provider
BS Binding Server
EAS Edge Application Server
ECS Edge Configuration Server
EDGEAPP Architecture for Enabling Edge Applications
EDN Edge Data Network
EEC Edge Enabler Client
EEL Edge Enabler Layer
EES Edge Enabler Server
IoT Internet of Things
OTT Over The Top
SA System Aspects
TS Technical Specification
UE User Equipment
V2X Vehicle-to-Everything
VR Virtual Reality.

1. A method performed by a first network function implementing a Binding Server (BS), comprising:
receiving, from a second network function implementing an Edge Enabler Server (EES) within an Edge Data Network (EDN), a request message including information related to an application in a User Equipment (UE) and a UE group which hosts the same application as the UE, and information related to a predetermined Edge Application Server (EAS) for the application of the UE;
determining a binding EAS to be used for the UE or the UE group based on the request message; and
transmitting, to the second network function, a response message, wherein the response message explicitly or implicitly indicates the binding EAS.

2. The method according to claim 1, determining a binding EAS to be used for the UE or the UE group further comprising at least one of:
creating a binding EAS or determining a binding EAS as the predetermined EAS, in response to determining that there is no existing binding EAS,
replacing the existing binding EAS with a binding EAS, in response to determining that there is the existing binding EAS and the binding EAS has better performance than the existing binding EAS.

3. (canceled)

4. The method according to claim 3, wherein the binding EAS is the same as the predetermined EAS, and the response message indicates that the predetermined EAS is used as the binding EAS.

5. The method according to claim 3, wherein the binding EAS is different from the predetermined EAS, and the response message indicates the binding EAS and a fourth network function implementing EES associated with the binding EAS.

6. The method according to claim 1, further comprising:
transmitting, to a third network function implementing an EES which are serving at least one UE in the UE group, a notification message, wherein the notification message indicates the binding EAS and a fourth network function implementing EES associated with the binding EAS.

7. The method according to claim 2, wherein the binding EAS has better average latency performance than the existing binding EAS.

8. The method according to claim 1, wherein the request message further includes at least one of a fourth parameter indicating identity of the UE, and a fifth parameter indicating information regarding the EDN.

9. The method according to claim 1, wherein the request message is a group binding request message;
wherein the response message is a group binding response message; and/or
wherein the notification message is a group binding notification message.

10. The method according to claim 1, wherein the first network function is located inside the EDN or outside the EDN.

11. The method according to claim 8, further comprising:
storing, in the first network function, the first parameter, the second parameter, the third parameter, the fourth parameter, the fifth parameter, and information regarding the second network function.

12. The method according to claim 1, wherein the UE group includes two or more UEs cooperating with each other to support a same function.

13-21. (canceled)

22. A method performed by a functional component implementing an enabler function in a User Equipment (UE), comprising:
receiving, from a second network function implementing an Edge Enabler Server (EES), a first message, wherein the first message explicitly or implicitly indicates a binding Edge Application Server (EAS) to be used for a UE group including the UE.

23. The method according to claim 22, wherein the first message further indicates a third network function implementing an EES associated with the binding EAS.

24. The method according to claim 22, further comprising:
transmitting, to the second network function, a second message including information related to an application in the UE and a UE group which includes the UE and hosts the same application as the UE, and information related to a predetermined Edge Application Server (EAS) for the application of the UE.

25. The method according to claim 24, wherein the first message indicates that the predetermined EAS is used as the binding EAS.

26. The method according to claim 22, wherein the binding EAS has better average latency performance than an existing binding EAS.

27. The method according to claim 22, wherein the first message is an EAS selection declaration response message or an EAS reselection request message; and/or
wherein the second message is an EAS selection declaration request message.

28. The method according to claim 22, wherein the UE group includes two or more UEs cooperating with each other to support a same function.

29. A first network function implementing Binding Server (BS), comprising:
at least one processor; and
a non-transitory computer readable medium coupled to the at least one processor, the non-transitory computer readable medium contains instructions executable by the at least one processor, whereby the at least one processor is configured to:
receiving, from a second network function implementing an Edge Enabler Server (EES) within an Edge Data Network (EDN), a request message including information related to an application in a User Equipment (UE) and a UE group which hosts the same application as the UE, and information related to a predetermined Edge Application Server (EAS) for the application of the UE;
determining a binding EAS to be used for the UE or the UE group based on the request message; and
transmitting, to the second network function, a response message, wherein the response message explicitly or implicitly indicates the binding EAS.

30-33. (canceled)
